(19) United States
(12) Patent Application Publication
(10) Pub. No.: US 2024/0046170 A1
(43) Pub. Date: Feb. 8, 2024

(54) DATA PROCESSING APPARATUS, DATA PROCESSING METHOD AND PROGRAM

(71) Applicant: NIPPON TELEGRAPH AND TELEPHONE CORPORATION, Tokyo (JP)

(72) Inventors: Satoshi TAKATSU, Musashino-shi, Tokyo (JP); Tomoko SHIBATA, Musashino-shi, Tokyo (JP); Masanobu SAKAMOTO, Musashino-shi, Tokyo (JP); Hiroshi YOSHIDA, Musashino-shi, Tokyo (JP)

(73) Assignee: NIPPON TELEGRAPH AND TELEPHONE CORPORATION, Tokyo (JP)

(21) Appl. No.: 18/268,796

(22) PCT Filed: Dec. 23, 2020
(86) PCT No.: PCT/JP2020/048276

§ 371 Date: Jun. 21, 2023

(51) Int. Cl. G06Q 10/0631; G06Q 10/04

(52) U.S. Cl. CPC G06Q 10/063112; G06Q 10/04

(57) ABSTRACT

According to an aspect of the present invention, an information processing device includes: an acquisition unit configured to acquire first and second restriction conditions that are restriction conditions related to a plurality of tasks or a plurality of workers; an allocation execution unit configured to allocate the plurality of workers to the plurality of tasks based on a time index having a plurality of weights based on the first restriction condition and generate an allocation result; a determination unit configured to determine whether the allocation result satisfies a determination condition based on the second restriction condition; a correction unit configured to correct a weight related to a task which is a factor by which the allocation result is determined not to satisfy the determination condition among the plurality of weights when the allocation result does not satisfy the determination condition; and an output unit configured to output the allocation result when the allocation result satisfies the determination condition.

### TECHNICAL FIELD

The present invention relates to a personnel resource allocation technology.

### BACKGROUND ART

In general, optimization calculation is performed using two axes of a time index and a quality index in solving a personnel resource allocation problem or a scheduling problem in consideration of restriction conditions such as workers' skills and task difficulties. For example, Patent Literature 1 discloses a scheduling method of minimizing the entire schedule time in consideration of workers' skills.

In the related art, when there are a large number of restriction conditions, one restriction condition is considered in a time index, and the remaining restriction conditions are considered in a quality index. That is, the restriction condition is reduced only to the quality index. For example, the movement time is considered in the time index, and the workers' skills and task difficulty levels are considered in the quality index.

As the restriction condition increases, calculation of the quality index becomes more complicated. In order to rewrite the restriction conditions in a constraint expression and reflect the constraint expression in a solver syntax, a person with skills related to an optimization solver is essential. The increase in the constraint expression results in an increase in a calculation time. An optimal solution may be unobtainable. Further, it becomes difficult to see which restriction condition affects the index, and the post-evaluation of the restriction conditions cannot be performed.

### CITATION LIST

### Patent Literature

Patent Literature 1: JP 2017-211921 A

### SUMMARY OF INVENTION

### Technical Problem

An objective of the present invention is to provide a technology for reducing restriction conditions in a time index.

### Solution to Problem

According to an aspect of the present invention, an information processing device includes: an acquisition unit configured to acquire first and second restriction conditions that are restriction conditions related to a plurality of tasks or a plurality of workers; an allocation execution unit configured to allocate the plurality of workers to the plurality of tasks based on a time index having a plurality of weights based on the first restriction condition and generate an allocation result; a determination unit configured to determine whether the allocation result satisfies a determination condition based on the second restriction condition; a correction unit configured to correct a weight related to a task which is a factor by which the allocation result is determined not to satisfy the determination condition among the plurality of weights when the allocation result does not satisfy the determination condition; and an output unit configured to output the allocation result when the allocation result satisfies the determination condition.

### Advantageous Effects of Invention

According to the present invention, a technology for reducing restriction conditions to a time index is provided.

### BRIEF DESCRIPTION OF DRAWINGS

FIG. 1 is a block diagram illustrating an information processing device according to an embodiment.

FIG. 2 is a diagram illustrating an arrangement example of work places of tasks.

FIG. 3 is a diagram illustrating an example of task data stored in a task data storage unit illustrated in FIG. 1.

FIG. 4 is a diagram illustrating an example of an allocation result.

FIG. 5 is a diagram for describing processing by a correction unit illustrated in FIG. 1.

FIG. 6 is a diagram illustrating an example of an allocation result obtained after weight correction.

FIG. 7 is a flowchart illustrating an example of a processing procedure in which an allocation unit illustrated in FIG. 1 performs allocation.

FIG. 8 is a block diagram illustrating an information processing device according to an embodiment.

FIG. 9 is a diagram illustrating a process performed by an allowable value decision unit illustrated in FIG. 8.

FIG. 10 is a diagram illustrating a process performed by the allowable value decision unit illustrated in FIG. 8.

FIG. 11 is a diagram illustrating a process performed by the allowable value decision unit illustrated in FIG. 8.

FIG. 12 is a block diagram illustrating a hardware configuration example of a computer according to an embodiment.

### DESCRIPTION OF EMBODIMENTS

Hereinafter, embodiments of the present invention will be described with reference to the drawings.

### [Configuration]

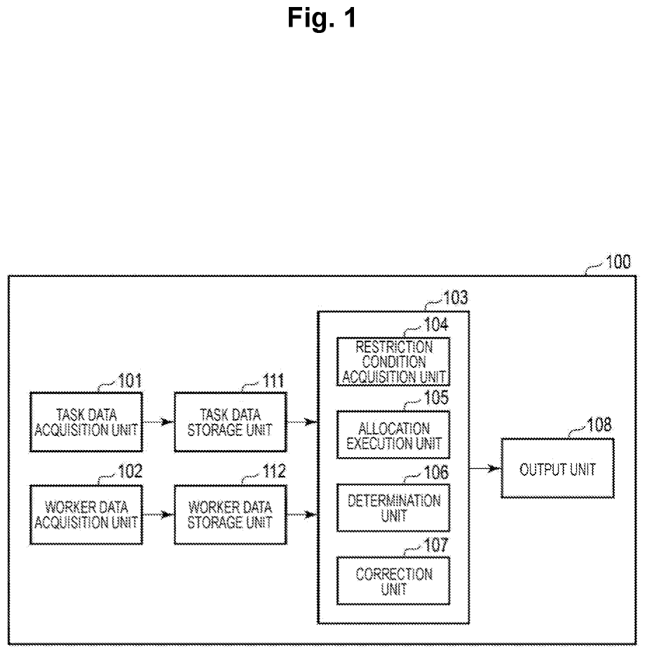

FIG. 1 schematically illustrates an information processing device 100 according to an embodiment. The information processing device 100 allocates a plurality of workers to a plurality of tasks to be executed. As illustrated in FIG. 1, the information processing device 100 includes a task data acquisition unit 101, a worker data acquisition unit 102, an allocation unit 103, an output unit 108, a task data storage unit 111, and a worker data storage unit 112. The information processing device 100 can be implemented by a computer such as a server or a personal computer.

The task data acquisition unit 101 and the worker data acquisition unit 102 acquire data necessary for allocation by the allocation unit 103.

The task data acquisition unit 101 acquires task data which is data related to a plurality of tasks and stores the task data in the task data storage unit 111. The task data may include basic data and movement time data. The basic data may include positional data for identifying a place (a work place) where each task is executed, start time data indicating a start time which is a time to start execution of each task, and data indicating the number of workers to be allocated to each task. The positional data may include, for example, an address of a work place. The basic data may further include data indicating a type of each task. The basic data may be input by a human operator. The movement time data indicates a time required for movement between the work places. The task data acquisition unit 101 may generate the movement time data with reference to a map information system using the positional data included in the basic data.

The worker data acquisition unit 102 acquires worker data which is data related to a plurality of workers and stores the worker data in the worker data storage unit 112. The worker data may include identification data (for example, an ID number) for identifying workers and data indicating an upper limit number of tasks to be allocated to each worker.

The allocation unit 103 allocates workers to tasks based on the task data stored in the task data storage unit 111 and the worker data stored in the worker data storage unit 112 and generates an allocation table as an allocation result. The allocation unit 103 includes a restriction condition acquisition unit 104, an allocation execution unit 105, a determination unit 106, and a correction unit 107.

The restriction condition acquisition unit 104 acquires restriction conditions related to the tasks from the task data stored in the task data storage unit 111. The restriction conditions related to the task include at least two restriction conditions. For example, the restriction condition acquisition unit 104 acquires two time restriction conditions: movement time data and start time data.

The allocation execution unit 105 allocates the workers to the tasks based on the time index having a plurality of weights based on the restriction conditions acquired by the restriction condition acquisition unit 104. A restriction condition on which a time index is based is referred to as a first restriction condition. For example, the first restriction condition includes a movement time between the work places, and the movement time between the work places is used as a weight. The first restriction condition may include a work time of a task instead of or in addition to the time between the work places of the task. The work time of the task is a time required to complete the task.

The determination unit 106 determines whether an allocation table generated by the allocation execution unit 105 satisfies a determination condition based on the restriction conditions acquired by the restriction condition acquisition unit 104. A restriction condition on which the determination condition is based is referred to as a second restriction condition. For example, the second restriction condition includes a task start time. The determination condition includes a condition that tasks of which start times are the same are not allocated to one worker. Alternatively, the determination condition may include a condition that a ratio of tasks of which the start times do not overlap with each other in all the tasks is restricted to be less than a predetermined threshold. This condition is a condition reflecting an allocator's idea that tasks of which the start times are the same are allocated to one person as little as possible. The determination condition may include a condition that the number of same types of tasks allocated to each worker is suppressed to be less than a predetermined threshold value. This condition is a condition reflecting an allocator's idea that the same type of task is allocated to one worker as little as possible and is based on a view point that a vocal sound of a worker's skill at processing different types of tasks will not improve when the worker is in charge of only the same type of task. The determination condition may include a condition that the number of workers to which tasks of which work places are located in dangerous areas (for example, highly infectious risk areas) are allocated is suppressed to be to less than a predetermined number. When the determination unit 106 determines that the allocation table satisfies the determination condition, the allocation table is given to the output unit 108.

When the determination unit 106 determines that the allocation table does not satisfy the determination condition, the correction unit 107 corrects a weight related to a task which is a factor of the determination that the allocation result does not satisfy the determination condition. Then, the allocation execution unit 105 performs the allocation again based on the time index of which the weight has been corrected and generates a new allocation table.

The output unit 108 outputs the allocation table generated by the allocation unit 103. For example, the output unit 108 displays the allocation table on a display device. Alternatively, the output unit 108 may transmit the allocation table to an external device connected via a network.

The allocation execution unit 105 obtains an allocation table by solving an optimization problem using the time index as an objective function. A linear programming problem which is one of optimization problems may be used. In this case, the time index is a linear combination of weights determined based on the first restriction condition. The time index f(x) can be expressed as, for example, the following expression (1).

f(x)=a₁x₁+a₂x₂+ . . . +aₙxₙ (1)

Here, aᵢ is a weight and xᵢ is a variable. When the first restriction condition is a movement time of a task between the work places, the weight aᵢ is the movement time between the work places of the two tasks, and the time index represents a sum of the movement times of the worker. When the movement time between work places is used as the first restriction condition, it is possible to perform allocation in which all the workers are assumed to move by the same movement method (for example, walking). The movement time between the work places depends on the distance between the work places. Therefore, a distance between work places may be used instead of the movement time between work places.

The allocation execution unit 105 performs allocation based on a linear programming problem that has the time index f(x) as an objective function. Specifically, the allocation execution unit 105 obtains a solution (x₁, x₂, . . . , xₙ) that minimizes the objective function f(x) under the constraint condition and generates an allocation table from the obtained solution. The constraint condition includes a condition that there is no task which cannot be allocated to anyone. The constraint condition may further include the number of workers in charge of each task, an upper limit number of tasks allocated to each worker, and the like. In the present embodiment, the number of workers in charge of each task is one, and the upper limit number of tasks allocated to each worker is three. When each task is executed by one worker, the variable xᵢ is, for example, 0 or 1. For example, when a₁ is a movement time between a work place of a task A and a work place of a task B, x₁=1 corresponds to the case in which the tasks A and B are allocated to any one worker and this worker moves between the work places of the tasks A and B and x₁=0 corresponds to the case in which no worker moves between the work places of the tasks A and B.

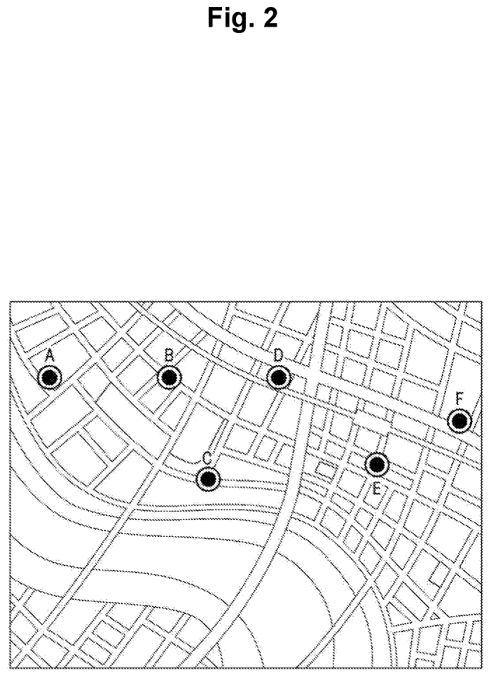

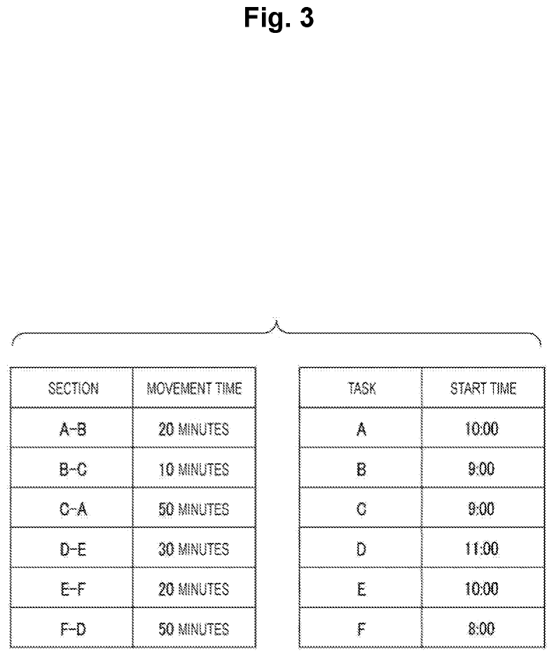

FIG. 2 illustrates an arrangement example of work places A to F of six tasks A to F and FIG. 3 illustrates an example of task data regarding the tasks A to F. As illustrated in FIG. 2, the work places A to F are geographically distant from each other. The task data includes movement time data indicating a movement time between places A and B, a movement time between places A and C, a movement time between places A and D, . . . , and a movement time between places E and F, and start time data indicating start times of the tasks A to F. There is the movement time for each of the fifteen sections formed by any two of the places A to F, but only the movement times for the six sections are illustrated in FIG. 3. As shown in FIG. 3, a movement time between places A and B is 20 minutes, a movement time between places B and C is 10 minutes, a movement time between places C and A is 50 minutes, a movement time between places D and E is 30 minutes, a movement time between places E and F is 20 minutes, and a movement time between places F and D is 50 minutes. A start time of the task A is 10:00, a start time of the task B is 9:00, a start time of the task C is 9:00, a start time of the task D is 11:00, a start time of the task E is 10:00, and a start time of the task F is 8:00. Hereinafter, the examples illustrated in FIGS. 2 and 3 will be referred to as reference examples.

In the reference example, the movement time between the places A and B is set to the weight a₁ (a₁=20), the movement time between the places A and C is set to the weight a₂ (a₂=50), the movement time between the places B and C is set to the weight a₆ (a₆=10), the movement time between the places D and E is set to the weight a₁₃ (a₁₃=30), the movement time between the places D and F is set to the weight a₁₄ (a₁₄=50), and the movement time between the places E and F is set to the weight a₁₅ (a₁₅=20).

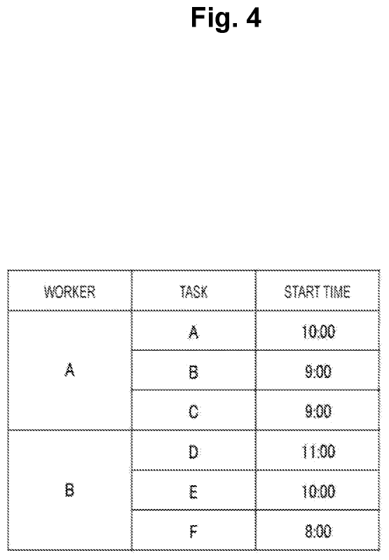

The optimization is executed without taking the second restriction condition (for example, the start times of the tasks) into consideration. In this case, an allocation table in which a plurality of tasks of which the start times are the same are allocated to one worker may be obtained. In the reference example, as illustrated in FIG. 4, the tasks A, B, and C may be allocated to the worker A, and the tasks D, E, and F may be allocated to the worker B. The start times of the tasks B and C are all 9:00, and the allocation table cannot be implemented. When the determination condition includes a condition that tasks of which start times are the same are not allocated to one worker, the allocation table does not satisfy the determination condition.

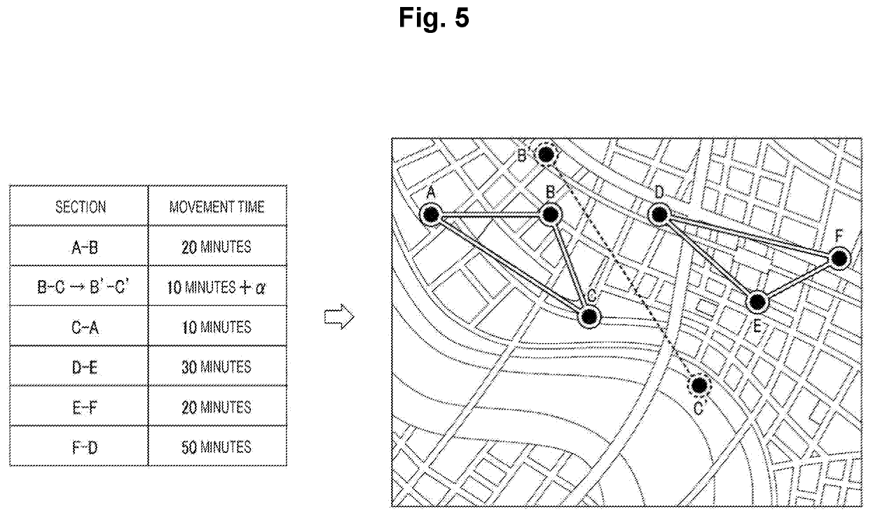

The correction unit 107 corrects a weight related to a task which is a factor by which the allocation table does not to satisfy the determination condition among the weights included in the time index. In the foregoing example, the tasks which are factors by which the allocation table does not satisfy the determination condition are the tasks B and C, and the correction unit 107 corrects the weight a₆ in which the movement time between the places B and C is set. For example, the correction unit 107 increases the weight a₆ by a predetermined value α (for example, 10 minutes). This corresponds to a virtually increase in a distance between places B and C, as illustrated in FIG. 5. Accordingly, both the tasks B and C are less likely to be allocated to one worker.

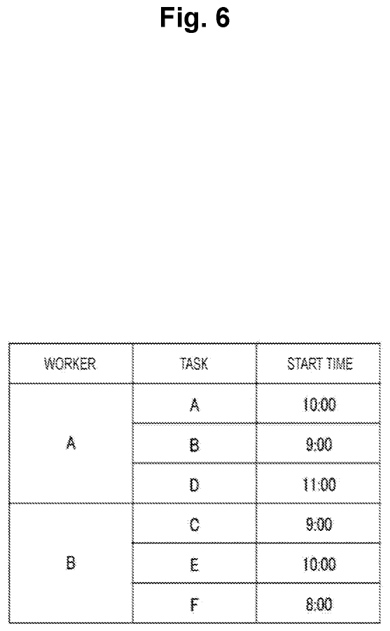

The allocation unit 103 performs the allocation again based on the time index in which the weight a₆ is corrected. Through the allocation performed again, as illustrated in FIG. 6, an allocation table in which the tasks A, B, and D are allocated to the worker A and the tasks C, E, and F are allocated to the worker B is obtained. In this way, overlapping of the start times of the tasks which is a problem is resolved.

### [Operation]

Next, an operation of the information processing device 100 will be described.

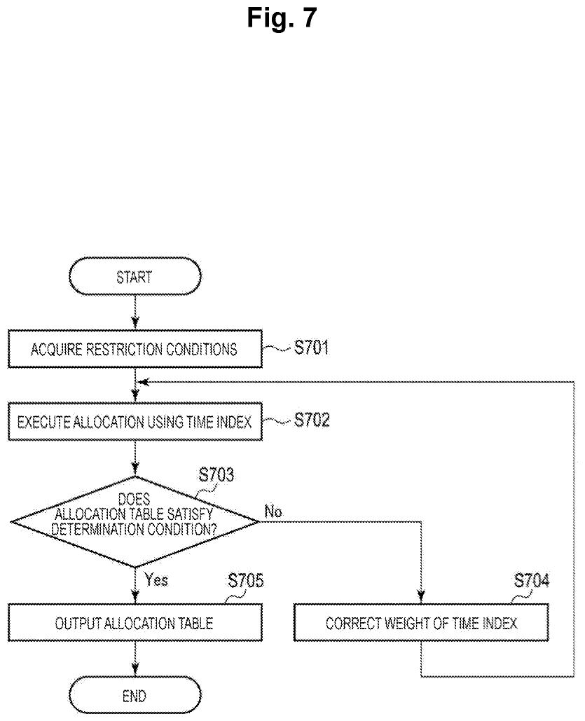

FIG. 7 schematically illustrates a procedure example of a process executed by the information processing device 100. In step S701 of FIG. 7, the restriction condition acquisition unit 104 acquires the first restriction condition and the second restriction condition that are restriction conditions regarding the task. For example, the restriction condition acquisition unit 104 generates the first and second restriction conditions from the task data stored in the task data storage unit 111. The first restriction condition includes, for example, a movement time between places where the tasks are executed and the second restriction condition includes, for example, the start times of the tasks.

In step S702, the allocation execution unit 105 allocates the worker to the task based on the time index having the weight based on the first restriction condition, and generates the allocation table. For example, the allocation execution unit 105 generates an allocation table by obtaining a solution to a linear programming problem using the time index f(x) expressed in the foregoing Expression (1) as an objective function. For example, a movement time between work places of tasks is used as a weight.

In step S703, the determination unit 106 determines whether the allocation table generated by the allocation execution unit 105 satisfies the determination condition based on the second restriction condition. For example, when tasks of which the start times are the same is allocated to one worker, the determination unit 106 determines that the allocation table does not satisfy the determination condition. When the allocation table does not satisfy the determination condition (step S703; No), the process proceeds to step S704.

In step S704, the correction unit 107 corrects the weight related to the task which is a factor by which the allocation table is determined not to satisfy the determination condition among the weights. For example, when two tasks of which the start times are the same are allocated to one worker, the correction unit 107 increases the weight in which the movement time between the work places of the two tasks is set by a predetermined value. Thereafter, the process returns to step S702, and the allocation execution unit 105 performs the allocation again based on the time index of which the weight has been corrected.

When the allocation table satisfies the determination condition (step S703; Yes), the process proceeds to step S705. In step S705, the output unit 108 outputs the allocation table. For example, the output unit 108 displays the allocation table on the display device.

An allocation table obtained by performing the allocation based on the time index of which the weight has been corrected may be output regardless of whether the allocation table satisfies the determination condition.

### Advantageous Effects

As described above, the information processing device 100 acquires the first and second restriction conditions which are the restriction conditions related to a plurality of tasks, and allocates a plurality of workers to a plurality of tasks based on the time index having a plurality of weights determined based on the first restriction condition to generate an allocation result. When the allocation result does not satisfy the determination condition based on the second restriction condition, the information processing device 100 corrects the weight related to the task that is a factor by which the allocation result is determined not to satisfy the determination condition and performs the allocation again based on the time index in which the weight has been corrected. When the allocation result that satisfies the determination condition is obtained, the information processing device 100 outputs the allocation result.

According to the foregoing configuration, the second restriction condition can be reduced to the time index without changing the time index (constraint expression). A plurality of restriction conditions can be handled with one time index. In a situation where there is no person with skills related to optimization, it is possible to perform the allocation in consideration of the second restriction condition. Since the time index is not changed, a time for the optimization calculation does not increase.

The information processing device 100 may generate an allocation result by solving a linear programming problem using a time index as an objective function. In this case, the time index is defined by a linear combination of the weights. Since the time index is evaluated with magnitude (a magnitude relation) of the value, quality of the applied restriction condition is clearer than the quality index. Therefore, the post-evaluation of the restriction condition becomes easy.

In the information processing device 100, it is possible to use a determination condition including permission such as a determination condition that a ratio of tasks of which the start times do not overlap each other in all the tasks is suppressed to be less than a predetermined threshold value. Accordingly, it is possible to eliminate or reduce the occurrence of an event in which a solution cannot be obtained in the optimization.

### Modified Example

An allocator may wish to allocate a combination of tasks in which a short movement time is required to one worker. In the above-described reference example, the movement time between the places E and F is relatively short, and the start times of the tasks E and F are different. In this case, the tasks E and F are desirably allocated to the same worker. The correction unit 107 may reduce the weight a₁₅ in which the movement time between the places E and F is set by a predetermined value (for example, 5 minutes). By reducing the weight a₁₅, the tasks E and F are more likely allocated to the same worker. In this manner, the correction unit 107 may correct the weight based on a positive condition.

In the above-described embodiment, the first restriction condition and the second restriction condition relate to a task. The first restriction condition and/or the second restriction condition may include a restriction condition related to the worker. It is assumed that there is a task to be executed by two workers. The worker data includes skill data indicating a skill level of each worker. Skills are classified into four levels: SA, S, A, and B. SA, S, A, and B are allocated in a descending order of skill. The first restriction condition includes a work time for each skill level in each task. For example, the work time of the task A is set to 30 minutes for the skill level SA, 35 minutes for the skill level S, 40 minutes for the skill level A, and 45 minutes for the skill level B. The second restriction condition includes the skill level of the worker, and the determination condition includes a condition that a set of workers of which skill level is B is prohibited from being allocated to one task. For example, when two workers that have the skill level B are allocated to the task A, the correction unit 107 increases the weight to which the work time of the skill level B in the task A is set. This prevents generation of an allocation result in which a specific task is executed only by a trainee (a worker that has a low skill).

In the above-described example, the correction unit 107 increases or decreases the weight by a predetermined value. Alternatively, the correction unit 107 may correct the weight using an allowable value to be described later.

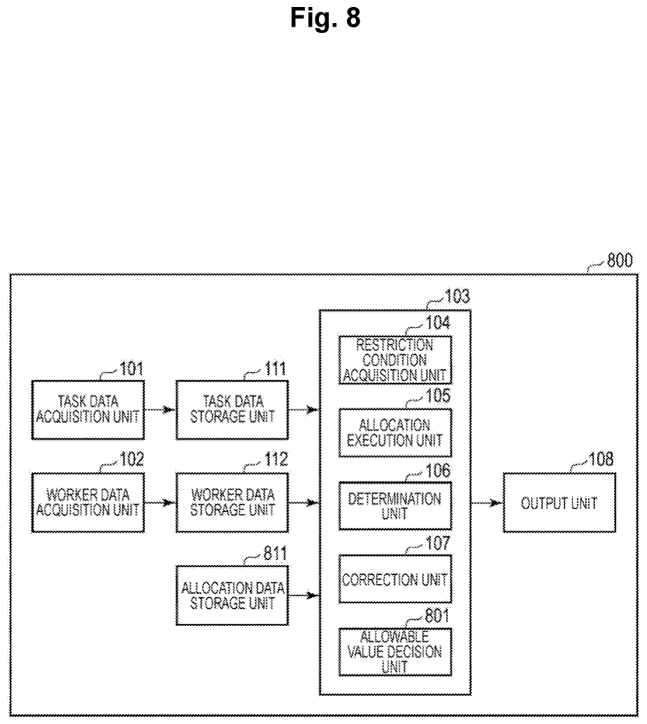

FIG. 8 schematically illustrates an information processing device 800 according to an embodiment. In FIG. 8, the same elements as those illustrated in FIG. 1 are denoted by the same reference numerals, and repeated description thereof will be omitted. As illustrated in FIG. 8, the information processing device 800 includes the task data acquisition unit 101, the worker data acquisition unit 102, the allocation unit 103, the output unit 108, the task data storage unit 111, the worker data storage unit 112, and an allocation data storage unit 811. The allocation unit 103 includes the restriction condition acquisition unit 104, the allocation execution unit 105, a determination unit 106, a correction unit 107, and an allowable value decision unit 801.

The allocation data storage unit 811 stores the allocation data. The allocation data includes a plurality of allocation tables manually generated by an allocator (human operator). Alternatively, the allocation data may include a plurality of allocation tables generated by a simulation.

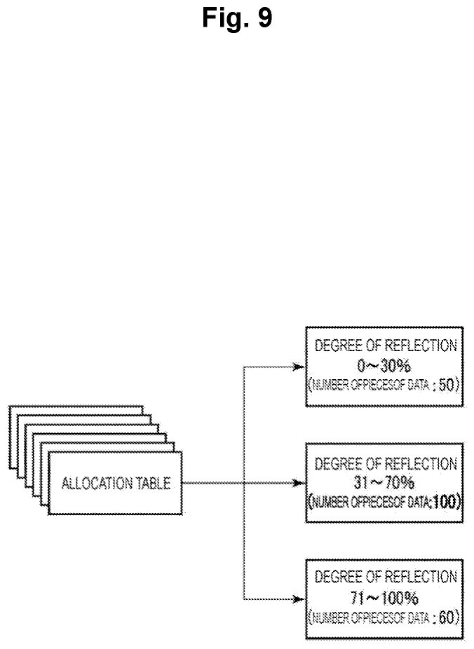

The allowable value decision unit 801 decides an allowable value based on the allocation history data stored in the allocation data storage unit 811. The allowable value decision unit 801 classifies a plurality of allocation tables included in the allocation data according to the degree of reflection of the second restriction condition. The degree of reflection refers to a ratio at which the second restriction condition is reflected in the allocation table. In an example in which the second restriction condition is start times of the tasks, the degree of reflection refers to a ratio of tasks of which start times do not overlap with each other in all the tasks. FIG. 9 illustrates an example of an allocation table in which nine tasks are allocated to three workers. In the example of FIG. 9, the tasks B and C of which the start times are the same are allocated to worker A, and the tasks E and F of which the start times are the same are allocated to the worker B. Therefore, the number of tasks in which the start times does not overlap with each other is five, and the degree of reflection is 56% (0.56≈5/9). For example, the allowable value decision unit 801 classifies a plurality of allocation tables into three classes. An allocation table having the degree of reflection in the range of 0 to 30% is classified to the first class, an allocation table having the degree of reflection in the range of 31 to 70% is classified to the second class, and an allocation table having the degree of reflection in the range of 71 to 100% is classified to the third class.

The allowable value decision unit 801 decides an allowable value based on an allocation table classified to a class in which the number of allocation tables (the number of pieces of data) is the largest. By determining the allowable value based on the allocation table classified to the class in which the number of allocation tables (the number of pieces of data) is the largest, it is possible to set an allowable value close to the interval of the allocator.

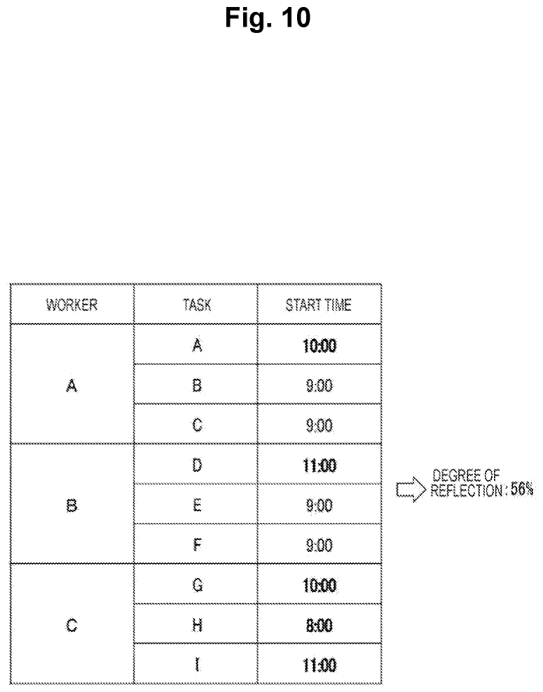

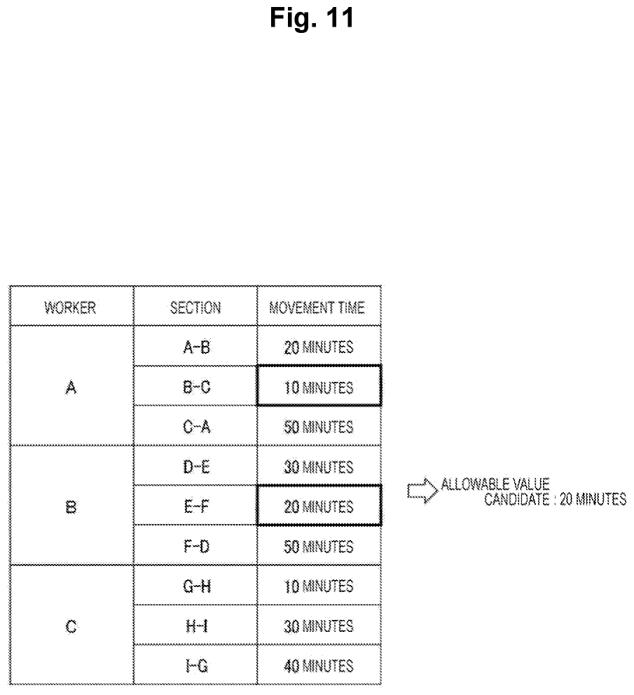

The allowable value decision unit 801 decides, as the allowable value, a largest value among the values of the time indexes in which the restriction conditions have not been reflected in the allocation table classified into the class in which the number of allocation tables is the largest. FIG. 10 illustrates one of the allocation tables classified to the class in which the number of allocation tables is the largest. In the allocation table illustrated in FIG. 10, the tasks B and C of which the start times are the same are allocated to the worker A, and a movement time between the work places of the tasks B and C is 10 minutes. Further, the tasks E and F of which the start times are the same are allocated to the worker B, and a movement time between the work places of the tasks E and F is 20 minutes. In the allocation table illustrated in FIG. 11, the allowable value candidate is 20 minutes. The allowable value candidates are acquired for all the allocation tables classified to the class in which the number of allocation tables is the largest. Of the allowable value candidates, the largest candidate is adopted as the allowable value. The allowable value obtained in this way is an upper limit value of the values allowed by the allocator, and enables allocation according to the sense of the allocator. The allowable value decision unit 801 notifies the correction unit 107 of the decided allowable value.

The allowable value may be decided in accordance with a method other than the foregoing method. For example, the allowable value may be a value obtained by subtracting an average movement time of all the sections excluding sections of which the start times overlap with each other from the average movement time of the sections of which the start times overlap with each other. The average movement time in the sections of which the start times overlap with each other is obtained by dividing a sum of the movement times of the sections of which the start times overlap with each other by the number of sections of which the start times overlap with each other. The average movement time of all the sections excluding the sections of which the start times overlap with each other is obtained by dividing the sum of the movement times of the sections other than the sections of which the start times overlap with each other by the number of sections excluding the sections of which the start times overlap with each other. When a negative allowable value is obtained, the allowable value may be calculated based on the foregoing method.

Using the allowable value decided by the allowable value decision unit 801, the correction unit 107 corrects the weight related to the task which is a factor by which the allocation table generated by the allocation unit 103 does not to satisfy the determination condition. In the example in which the tasks B and C of which the start times are the same are allocated to the worker A, the correction unit 107 corrects the weight a₆ corresponding to the movement time between the places B and C. When the movement time between the place B and the place C is less than the allowable value, the correction unit 107 corrects the value of the weight a₆ to the allowable value. For example, when the movement time between the places B and C is 10 minutes and the allowable value is 20 minutes, the correction unit 107 corrects the weight a₆ to 20 minutes. In other words, the correction unit 107 increases the weight a₆ by a difference between the allowable value and the movement time between the places B and C. When the movement time between the places B and C is equal to or exceeds the allowable value, the correction unit 107 does not correct the weight a₆. For example, when the movement time between places B and C is 30 minutes and the allowable value is 20 minutes, the weight a₆ is maintained at 30 minutes. When no weight is corrected, the same allocation table is obtained even if the allocation is performed again. Therefore, when no weight is corrected, the output unit 108 may output the obtained allocation table.

The processes described above with respect to the information processing device 100 and/or the information processing device 800 can be implemented by a computer.

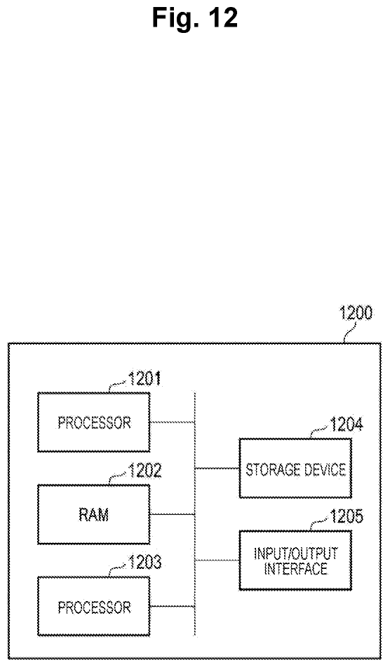

FIG. 12 schematically illustrates a hardware configuration example of a computer 1200 according to an embodiment. As illustrated in FIG. 12, a computer 1200 includes a processor 1201, a random access memory (RAN) 1202, a program memory 1203, a storage device 1204, and an input/output interface 1205. The processor 1201 controls the RAM 1202, the program memory 1203, the storage device 1204, and the input/output interface 1205 and exchanges signals with them.

The processor 1201 includes a general-purpose circuit such as a central processing unit (CPU) or a graphics processing unit (GPU). The RAM 1202 is used as a working memory by the processor 1201. The RAM 1202 includes a volatile memory such as an SDRAM. The program memory 1203 stores a program which is executed by the processor 1201 including an allocation program. The programs include computer-executable instructions. For example, a ROM is used as the program memory 1203. A partial area of the storage device 1204 may be used as the program memory 1203.

The processor 1201 loads a program stored in the program memory 1203 to the RAM 1202 to interpret and execute the program. When the allocation program is executed by the processor 1201, the allocation program causes the processor 1201 to perform the above-described processes with respect to the information processing device 100 and/or the information processing device 800.

The program may be supplied to the computer 1200 in a state of being stored in a computer-readable recording medium. In this case, the computer 1200 includes a drive that reads data from a recording medium and acquires a program from the recording medium. Examples of the recording medium include a magnetic disk, an optical disc (CD-ROM, CD-R, DVD-ROM, DVD-R, or the like), a magneto-optical disk (MO or the like), and a semiconductor memory. The program may be distributed through a network. Specifically, the program may be stored in a server on the network and the computer 1200 may download the program from the server.

The storage device 1204 stores data such as task data and worker data. The storage device 1204 includes a nonvolatile memory such as a hard disk drive (HDD) or a solid state drive (SSD).

The input/output interface 1205 includes a communication module communicating with an external device and a plurality of terminals connecting peripheral devices. The communication module includes a wired module and/or a wireless module. Examples of the peripheral device include a display device, a keyboard, and a mouse. The processor 1201 acquires data such as task data and worker data via the input/output interface 1205. The processor 1201 outputs an allocation result via the input/output interface 1205.

At least some of the processes described above with respect to the information processing device 100 and/or the information processing device 800 may be performed by a dedicated circuit such as ASIC or FPGA.

The present invention is not limited to the foregoing embodiments and various modifications can be made in the implementation stage without departing from the gist of the invention. The embodiments may be combined appropriately. In this case, combined advantageous effects can be obtained. Further, the foregoing embodiments include various inventions, and various inventions can be extracted in combinations selected from the plurality of disclosed components. For example, when the problem can be solved and the advantageous effects can be obtained despite elimination of some components from all the components described in the embodiments, a configuration from which the components are eliminated can be extracted as an invention.

### REFERENCE SIGNS LIST

100 Information processing device
101 Task data acquisition unit
102 Worker data acquisition unit
103 Allocation unit
104 Restriction condition acquisition unit
105 Allocation execution unit
106 Determination unit
107 Correction unit
108 Output unit
111 Task data storage unit
112 Worker data storage unit
800 Information processing device
801 Allowable value decision unit
811 Allocation data storage unit
1200 Computer
1201 Processor
1202 RAM
1203 Program memory
1204 Storage device
1205 Input/output interface

1. An information processing device comprising:
a processor; and
a storage medium having computer program instructions stored thereon, when executed by the processor, perform to:
acquire first and second restriction conditions that are restriction conditions related to a plurality of tasks or a plurality of workers;
allocate the plurality of workers to the plurality of tasks based on a time index having a plurality of weights based on the first restriction condition and generate an allocation result;
determine whether the allocation result satisfies a determination condition based on the second restriction condition;
correct a weight related to a task which is a factor by which the allocation result is determined not to satisfy the determination condition among the plurality of weights when the allocation result does not satisfy the determination condition; and
output the allocation result when the allocation result satisfies the determination condition.

2. The information processing device according to claim 1, wherein the computer program instructions further perform to obtains the allocation result by solving a linear programming problem using the time index as an objective function.

3. The information processing device according to claim 1, wherein the first restriction condition includes a movement time or a distance between places where the plurality of tasks are executed.

4. The information processing device according to claim 1, wherein the second restriction condition includes start times of the plurality of tasks.

5. The information processing device according to claim 4, wherein the determination condition includes a condition that a ratio of tasks of which the start times do not overlap with each other in the plurality of tasks is suppressed to be less than a predetermined threshold.

6. The information processing device according to claim 1 wherein the computer program instructions further perform to
decide an allowable value of weight correction based on a plurality of allocation results prepared in advance, and
corrects the weight based on the allowable value.

7. An information processing method comprising:
acquiring first and second restriction conditions that are restriction conditions related to a plurality of tasks or a plurality of workers;
allocating the plurality of workers to the plurality of tasks based on a time index having a plurality of weights based on the first restriction condition and generating an allocation result;
determining whether the allocation result satisfies a determination condition based on the second restriction condition;
correcting a weight related to a task which is a factor by which the allocation result is determined not to satisfy the determination condition among the plurality of weights and performing the allocation again based on the time index in which the weight has been corrected when the allocation result does not satisfy the determination condition; and
outputting the allocation result when the allocation result satisfies the determination condition.

8. A non-transitory computer-readable medium having computer-executable instructions that, upon execution of the instructions by a processor of a computer, cause the computer to function as the information processing device according to claim 1.
